(19) United States
(12) Patent Application Publication
(10) Pub. No.: US 2014/0105546 A1
(43) Pub. Date: Apr. 17, 2014

(54) FERRULE SYSTEM FOR FIBER OPTIC CONNECTORS

(71) Applicant: Corning Cable Systems LLC, Hickory, NC (US)

(72) Inventors: Adra Smith Baca, Rochester, NY (US); Daniel Warren Hawtof, Corning, NY (US); Thomas Dale Ketcham, Horseheads, NY (US); Robert Michael Morena, Lindley, NY (US)

(73) Assignee: Corning Cable Systems LLC, Hickory, NC (US)

(21) Appl. No.: 13/790,512

(22) Filed: Mar. 8, 2013

Related U.S. Application Data
(60) Provisional application No. 61/713,798, filed on Oct. 15, 2012.

(51) Int. Cl. G02B 6/38

(52) U.S. Cl. CPC G02B 6/3854
USPC 385/78; 385/139

(57) ABSTRACT

An optical waveguide ferrule includes a body and a low-expansion material on one end of the body. The body of the ferrule is formed from a first material and has a bore extending lengthwise therethrough. The bore is configured to receive an optical fiber along a central axis of the ferrule. The low-expansion is configured to be heated without damaging the body.

### RELATED APPLICATIONS

This application claims the benefit of priority under 35 U.S.C. §119 of U.S. Provisional Application Ser. No. 61/713,798 filed on Oct. 15, 2012, the content of which is relied upon and incorporated herein by reference in its entirety.

### BACKGROUND

Aspects of the present disclosure relate generally to a ferrule system for a fiber optic connector, and methods of manufacturing and using the same.

Typical practice for manufacture of optical fibers attached to hardened ferrules includes attachment of a stripped fiber using epoxy to a hardened ferrule. The fiber is mechanically- or laser-cleaved, and then the end of the fiber and ferrule are polished semi-manually, which can be tedious and expensive. To speed manufacturing it is desired to be able to use lasers, particularly an industrial CO₂ laser, to cleave and polish the optical fiber and ferrule. However, Applicants have found that using an industrialized CO₂ laser, at the intensity, pulse repetition, sweep speed, polarization etc. that would be useful to cleave and machine the optical fiber, can induce fractures in the ferrule. A need exists for a ferrule system that facilitates use of a high-powered laser to cleave and machine, without substantially damaging the ferrule.

### SUMMARY

Technology disclosed herein includes compositions, geometry of compositions, and processes for manufacturing and using a ferrule that allows for laser machining without ferrule damage while retaining good mechanical properties in the ferrule.

At least one embodiment relates to a ceramic optical waveguide ferrule including a region of a low-expansion material, preferably a glass or glass-ceramic. The region is confined to the end of the ceramic ferrule. The interface between the ceramic ferrule and the low-expansion material can be sharp (i.e., immediate), layered, or graded. In particular, technology disclosed herein includes a composite ferrule designed to mitigate damage by laser interaction with a low expansion material near an optical waveguide when the optical waveguide and ferrule surface are machined by the laser. At the same time, the ferrule is mechanically reliable, meaning that the ferrule can be connected and disconnected many times in extreme environmental conditions. This technology allows rapid machining and polishing of a ferrule and waveguide(s) for the manufacture of optical cables, cable assemblies, and/or fiber optic connectors.

Additional aspects of the technology disclosed herein include a rapid, automated process for manufacture of the ferrules, including laser sintering and/or bonding of low-expansion glass and/or glass-ceramic to a ferrule, such as a tough, durable zirconia ferrule.

Technology disclosed herein allows automated cleaving and machining of optical fibers and/or ferrules for optical cables. In some embodiments, this technology includes use of industry-standard ferrules modified as disclosed herein. In some embodiments, this technology includes use of ferrules formed from zirconia material, such as a zirconia 3 mole % Y₂O₃, in the same shape as an industry-standard ferrule—but with a modified end that allows laser machining without damage to the ferrule. Processes for ferrule manufacture disclosed herein can be automated, may be extremely rapid, and may use very little extra material, where the extra material used is neither exotic nor expensive. Further, the processes disclosed herein may use rugged, industrialized CO₂ lasers.

Additional features and advantages are set forth in the Detailed Description that follows, and in part will be readily apparent to those skilled in the art from the description or recognized by practicing the embodiments as described in the written description and claims hereof, as well as the appended drawings. It is to be understood that both the foregoing general description and the following Detailed Description are merely exemplary, and are intended to provide an overview or framework to understand the nature and character of the claims.

### BRIEF DESCRIPTION OF THE FIGURES

The accompanying Figures are included to provide a further understanding, and are incorporated in and constitute a part of this specification. The drawings illustrate one or more embodiments, and together with the Detailed Description serve to explain principles and operations of the various embodiments. As such, the disclosure will become more fully understood from the following Detailed Description, taken in conjunction with the accompanying Figures, in which:

FIG. 1 is a schematic diagram of a ferrule in cross-section according to an exemplary embodiment.

FIGS. 2-4 are schematic diagrams of ferrules in cross-section according to other exemplary embodiments.

FIG. 5 is a schematic diagram of a process of using a ferrule according to an exemplary embodiment.

FIG. 6 is a plot including radial stress in a hypothetical ferrule according to an exemplary embodiment.

FIG. 7 is a plot including circumferential stress in the hypothetical ferrule.

FIG. 8 is a scanning electron microscope (SEM) micrograph of a silica rod in a low-expansion, low-temperature sintering glass, glass-ceramic according to an exemplary embodiment.

FIG. 9 is an optical micrograph of sintered silica powder and a bonded thin silica sheet on zirconia according to an exemplary embodiment.

FIG. 10 is a schematic diagram of a multi-fiber ferrule in cross-section according to an exemplary embodiment.

### DETAILED DESCRIPTION

Before turning to the following Detailed Description and Figures, which illustrate exemplary embodiments in detail, it should be understood that the present disclosure is not limited to the details or methodology set forth in the Detailed Description or illustrated in the Figures. For example, as will be understood by those of ordinary skill in the art, features and attributes associated with embodiments shown in one of the Figures or described in the text relating to one of the embodiments may well be applied to other embodiments shown in another of the Figures or described elsewhere in the text.

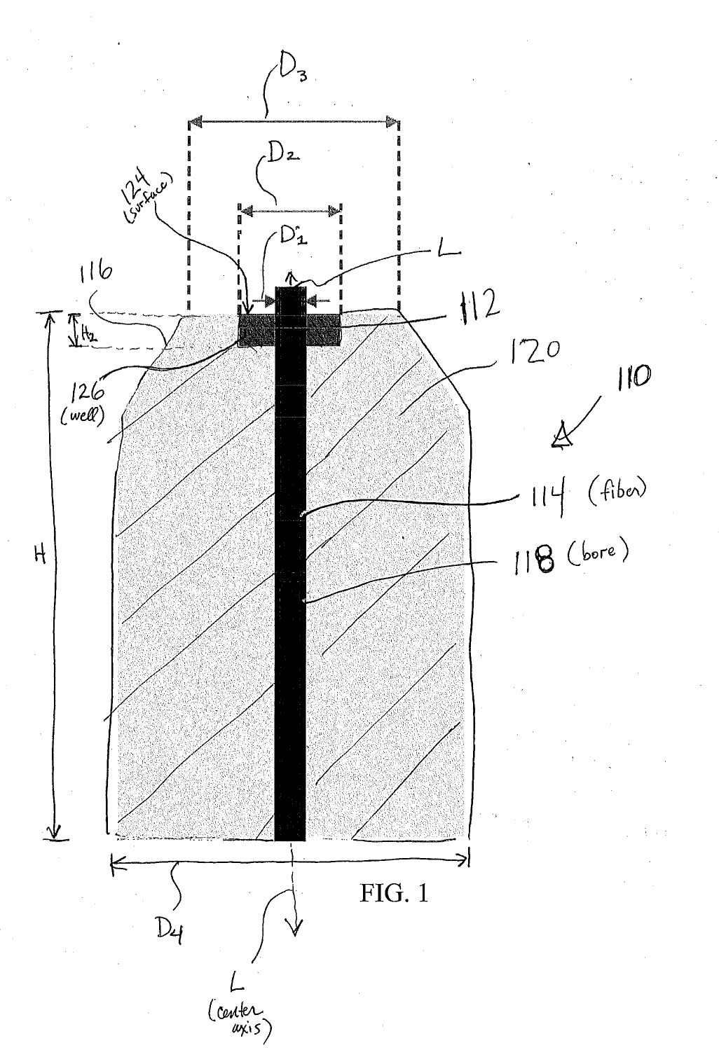

Referring generally to FIGS. 1-4, an optical waveguide ferrule 110, 210, 310, 410, in some embodiments, has a low-expansion, inorganic material 112, 212, 312, 412 surrounding an optical fiber 114, 214, 314, 414 on a cleaved end 116, 216, 316, 416 of the ferrule 110, 210, 310, 410. According to an exemplary embodiment, the low-expansion material 112, 212, 312, 412 extends more than 25 microns from central axis of the fiber 114, 214, 314, 414 (e.g., more than 25 microns from a bore 118, 218, 318, 418 of the ferrule 110, 210, 310, 410) but extends less than 90% of the radius (D₄/2) of the ferrule 110, 210, 310, 410 (e.g., outermost radius (D₄/2) of a round ferrule 110, 210, 310, 410), as measured perpendicular to the fiber long axis L. In some such embodiments, the low-expansion material 112, 212, 312, 412 extends into the ferrule 110, 210, 310, 410 less than half the depth H of the ferrule 110, 210, 310, 410, as measured parallel to the long axis L of the optical fiber 114, 214, 314, 414 (e.g., less than a tenth the length H of the ferrule 110, 210, 310, 410; does not extend into the ferrule 410 at all (see FIG. 4), but extends therefrom in a coating or end-layer 422). According to an exemplary embodiment, the difference in thermal expansion coefficient (CET; also CTE) of the material of the body 120, 220, 320, 420 of the ferrule 110, 210, 310, 410 and the low-expansion material 112, 212, 312, 412 is greater than 30×10⁻⁷/° C.

Referring specifically to FIG. 1, a small disk of low-expansion glass or glass ceramic 112 is embedded in a zirconia ferrule body 120 on a front end 116 thereof. According to an exemplary embodiment, the disk 112 is made of a material with a low enough CET that the material will not fracture when a CO₂ laser is used to cleave and polish the optical waveguide 114 and front surface 124 of the low expansion material 112.

In some embodiments, the ferrule 110 is beveled proximate to the forward end 116, which tapers to a generally flat face 124. In some embodiments the flat face 124 is round and less than 1.5 mm in diameter D₃, such as less than 1.25 mm or about 1.1 mm. Some exemplary size values D₂ of the disk 112 (or otherwise shaped volume of low-expansion material 112) are about 375 micrometers in outer diameter D₂ with a hole for a fiber of about 125 micrometers in diameter D₁, which includes a relatively small area of glass, glass-ceramic in a disk-shaped depression (well) 126 in a zirconia ferrule body 120. As shown in FIG. 1, the disk of low-expansion material 112 is centered co-axially on the end face 124 about the bore 118 for an optical fiber 114.

In some embodiments, the disk 112 diameter D₂ is narrower than the end face 124, such as less than half the diameter D₃ of the end face 124, such as less than 500 microns, such as about 375 microns or less. In some embodiments, the low-expansion material 112 may not be round (e.g., may be rectangular, elliptical, oblong, diamond-shaped), and the area of the low-expansion material 112 is less than the area of the end face 124 of the ferrule 110, such as less than two-thirds the area, such as less than half the area. According to an exemplary embodiment, the optical fiber 114 is positioned in the bore 118 and is narrower in diameter D₁ than the low-expansion material 112, such as less than half the largest cross sectional dimension (e.g., less than half the diameter D₂ of the disk 112), such as about 125 microns in diameter D₁, as shown in FIG. 1.

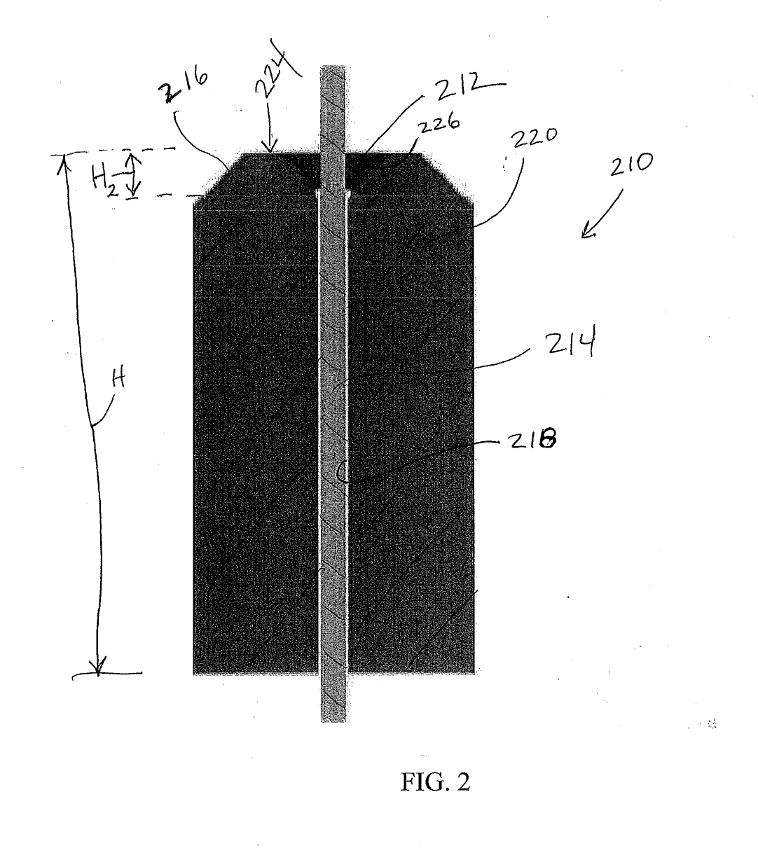

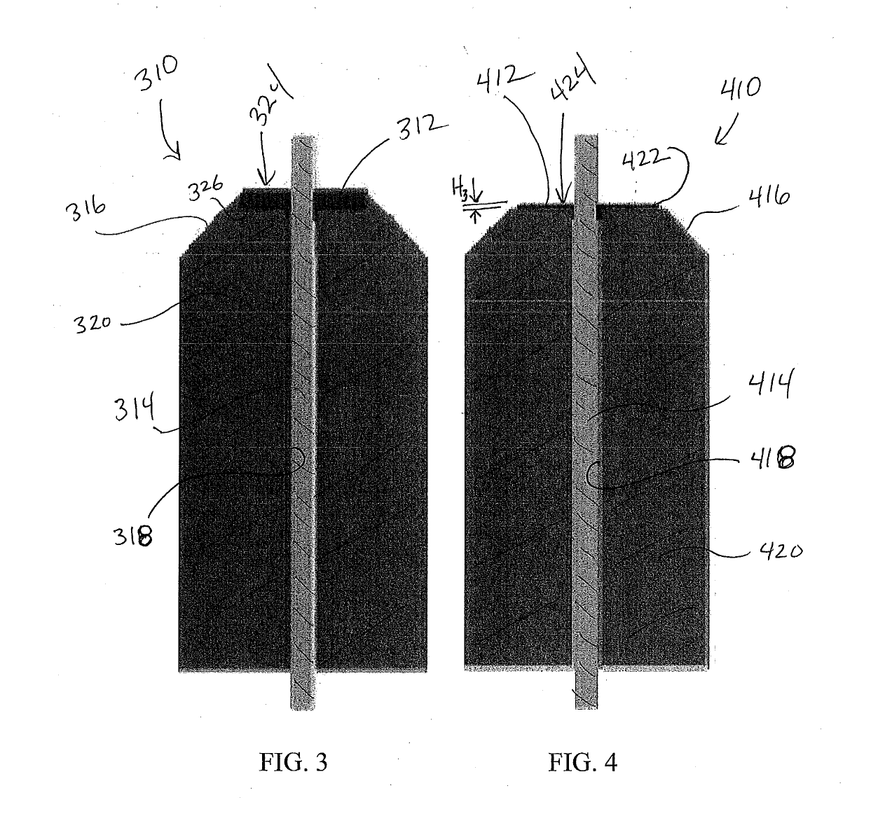

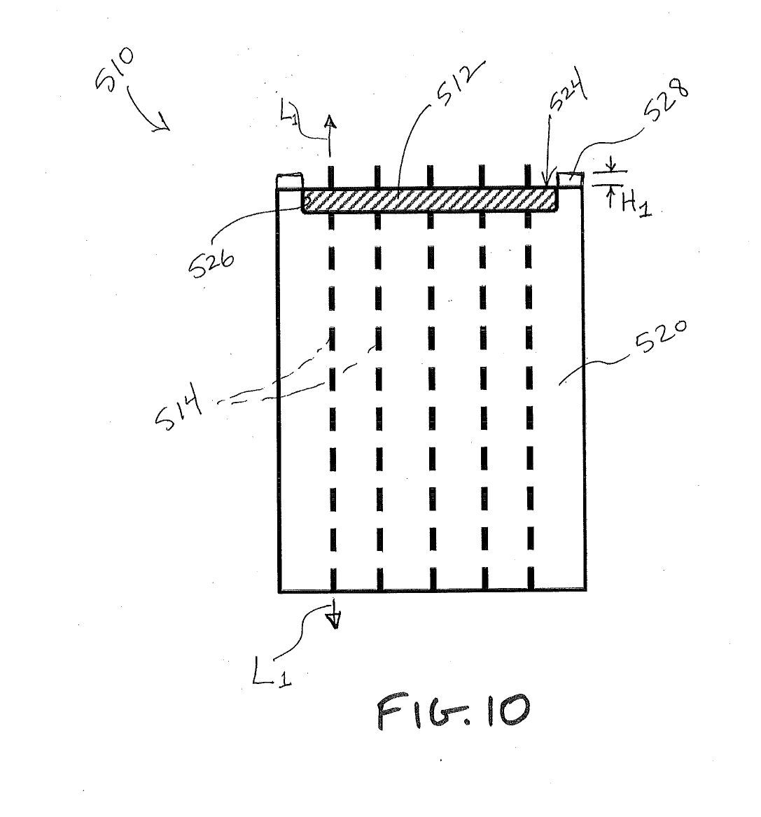

FIGS. 2-4 include other possible configurations of such a ferrule 210, 310, 410. The low-expansion material 212, 312, 412 is coupled directly to the end face 224, 324, 424 of the ferrule 210, 310, 410, and cover some or all of the end face 224, 324, 424 interior to the bevel 216, 316, 416. In other contemplated embodiment, the ferrule 210, 310, 410 does not include a bevel, and the end face 224, 324, 424 is defined by the portion of the ferrule 210, 310, 410 configured to interface with an adapter face or other connector end face. In contemplated embodiments, zirconia or other tough material 120, 220, 520 (FIGS. 1-2 and 10) surrounding the low-expansion material 112, 212, 512 on the end face 124, 224, 524 extends further along the length direction L (FIG. 1; see also fiber axis L₁ of FIG. 5) of the ferrule 110, 210, 510 than the low-expansion material 112, 212, 512 and/or the end of the optical fiber 114, 214, 514 proximate to the low-expansion material 112, 212, 512 thereby protecting the low-expansion material 112, 212, 512 and/or the optical fiber 114, 214, 514 from wear associated with physical contact (i.e., serves as a bumper; see, e.g., bumper 528 as shown in FIG. 10, which may also be used with single-fiber ferrules 110, 210, 310, 410). In some such embodiments, the bumper 528 extends a distance H₁ (FIG. 5) of at least 5 micrometers (on average) beyond the low-expansion material 112, 212, 512 and/or optical fiber 114, 214, 514, such as at least 10 micrometers, at least 25 micrometers, etc. In some such embodiments or other embodiments, the bumper 528 extends less than 1000 micrometers (on average) beyond the low-expansion material 112, 212, 512 and/or optical fiber 114, 214, 514, such as less than 500 micrometers, less than 200 micrometers, etc. A lens on the end of the optical fiber 114, 214, 514 and/or a large-core of the optical fiber 114, 214, 514, such as with multimode optical fibers, may facilitate communication of an optical signal without physical contact between the optical fiber 114, 214, 514 and another optical fiber mating therewith.

As shown in FIG. 2, the low-expansion material 212 may extend into the ferrule 210 in an annular manner about the bore 218, where the low-expansion material 212 extends in an inverted cone pointed into the ferrule body 220. As shown in FIG. 3, the low-expansion material 312 may entirely or nearly entirely cover the end face 324 of the ferrule 310. The low-expansion material 412 may be coated on the end-face 424 as the layer 422, as shown in FIG. 4, where the thickness H₃ of the coating layer 422 is less than 500 microns, such as less than 250 microns, such as thinner than the diameter D₁ of the optical fiber 114, 214, 314, 414. In other embodiments, the coating layer 422 may have a different thickness. Coating of the ferrule 110, 210, 310, 410 may allow for use of industry-standard ferrules manufactured elsewhere, and then modified via the coating layer 422, without machining a well 126, 226, 326 in the ferrule 410.

In at least some preferred embodiments, an optical waveguide ferrule 110, 210, 310, 410 includes a low-expansion material 112, 212, 312, 412 coupled thereto as disclosed above, where the low-expansion material 112, 212, 312, 412 is a glass, glass-ceramic. In some of those embodiments, preferred is an optical waveguide ferrule 110, 210, 310, 410 where the low-expansion material 112, 212, 312, 412 has a composition graded so that the low-expansion material 112, 212, 312, 412 is more than 5 volume-percentage different near the optical fiber 114, 214, 314, 414 (e.g., adjoining the bore 118, 218, 318, 418) compared to near the body 120, 220, 320, 420 of the ferrule 110, 210, 310, 410 (e.g., exterior sides opposite to the bore 118, 218, 318, 418). In some such embodiments, also preferred is an optical waveguide ferrule 110, 210, 310, 410 where the low-expansion material 112, 212, 312, 412 has composition graded from low-expansion (e.g., lower CET) near the optical fiber 114, 214, 314, 414 to higher-expansion near the body 120, 220, 320, 420 of the ferrule 110, 210, 310, 410 (e.g., higher CET). In some preferred embodiments of such an optical waveguide ferrule 110, 210, 310, 410, the low-expansion material 112, 212, 312, 412 has a region of lower Young's modulus (e.g., having increased porosity) between the optical fiber 114, 214, 314, 414 and the body 120, 220, 320, 420 of the ferrule 110, 210, 310, 410.

In at least some preferred embodiments, an optical waveguide ferrule 110, 210, 310, 410 has a low-expansion, inorganic material 112, 212, 312, 412 on the one end 124, 224, 324, 424 of the ferrule 110, 210, 310, 410, where the low-expansion material 112, 212, 312, 412 extends more than 25 microns from central axis L of the ferrule 110, 210, 310, 410 but to less than 90% of the radius (D₄/2) of the outer body 120, 220, 320, 420 of the ferrule 110, 210, 310, 410, as measured perpendicular to the ferrule long axis L. The low-expansion material 112, 212, 312 extends into the ferrule 112, 212, 312 a distance H₂ (FIG. 2) less than half the depth H of the ferrule 110, 210, 310, as measured along the long axis of the ferrule L. The difference in thermal expansion (CET) of the material of the body 120, 220, 320, 420, 520 of the ferrule 110, 210, 310, 410, 510 and the low-expansion material 112, 212, 312, 412, 512 is greater than 30×10⁻⁷/° C. Also preferred, in some such embodiments, is that the low-expansion material 112, 212, 312, 412, 512 is an inorganic crystalline material.

According to an exemplary embodiment, an optical waveguide ferrule 110, 210, 310, 410, 510 as disclosed herein (see generally FIGS. 1-4) has low-expansion material 112, 212, 312, 412, 512 containing an inorganic crystalline material including at least one of SiC, SiO₂, Si₃N₄, and solid solutions and multiple phases made from a polymer precursor. One embodiment includes an optical waveguide ferrule 110, 210, 310, 410, 510 where the low-expansion material 112, 212, 312, 412, 512 includes (e.g., comprises, primarily consists of, consists essentially of, and/or consists of) silica. One embodiment includes an optical waveguide ferrule 110, 210, 310, 410, 510 where the low-expansion material 112, 212, 312, 412, 512 is includes boro-silicate and/or beta-quartz.

In some preferred embodiments, an optical waveguide ferrule 110, 210, 310, 410, 510, as disclosed herein, includes low-expansion material 112, 212, 312, 412, 512 that includes a mixture of a low-temperature sintering glass, glass A (mole %): 59.08 SiO₂, 13.33 B₂O₃, 9.37 Al₂O₃, 8.03 Na₂O, 4.09 CaO, 1.28 Li₂O, 1.64 K₂O, 1.79 MgO, 1.37 ZrO₂; and a low-expansion glass-ceramic, Glass B (mole %): 60.0 SiO₂, 20.0 Al₂O₃, 20.0 ZnO. In other preferred embodiments, an optical waveguide ferrule 110, 210, 310, 410, 510, as disclosed herein, includes low-expansion material 112, 212, 312, 412, 512 that includes a mixture of a low-temperature sintering glass, glass A (mole %): 59.08 SiO₂, 13.33 B₂O₃, 9.37 Al₂O₃, 8.03 Na₂O, 4.09 CaO, 1.28 Li₂O, 1.64 K₂O, 1.79 MgO, 1.37 ZrO₂; and a low-expansion glass-ceramic, Glass C (mole %): 59.0 SiO₂, 19.6 Al₂O₃, 12.4 ZnO, 6.8 Li₂O, 2.2 ZrO₂. In some embodiments, the low-expansion material 112, 212, 312, 412, 512 includes a pre-formed silica and/or boro-silicate interior with a lower melting glass interface.

In some preferred embodiments, a zirconia optical waveguide ferrule 110, 210, 310, 410 has a low-expansion glass 112, 212, 312, 412 surrounding the optical fiber 114, 214, 314, 414 on the cleaved end 116, 216, 316, 416 of the ferrule. The glass 112, 212, 312, 412 extends more to than 100 microns from the fiber 114, 214, 314, 414, but less than 250 microns as measured perpendicular to the fiber long axis L (radially). In some such embodiments, the glass 112, 212, 312, 412, 512 extends less than 1 mm deep in terms of distance H₂ into the ferrule 110, 210, 310, 410, 510, as measured along the long axis L or L₁ of the optical fiber 114, 214, 314, 414, 514.

Referring to FIG. 5, a fast heating process includes using a laser 328 (i.e. beam). Heating and sintering/bonding of the glass 312, 314 occurs fast enough that the entire ferrule 310 is not heated to the sintering/bonding temperature. For example, a laser 328 may be used to thermally sinter silica powder/soot or other low-expansion glass, while keep the ferrule 110, 210, 310, 410, 510 as near to room temperature as possible. In some embodiments, if room temperature is 20° C., then, following use of the laser 328, the mean temperature of the ferrule body 120, 220, 320, 420, 520 (not including the low-expansion material 112, 212, 312, 412, 512 and optical fiber 114, 214, 314, 414, 514) is less than 50° C., such as less than 30° C., whereby the ferrule 110, 210, 310, 410, 510 is not damaged by the laser heating process. The low-expansion material 112, 212, 312, 412, 512 has a particularly low CET×≢T, where CET is coefficient of thermal expansion and ΔT is change in temperature. As such, only minimal changes, with respect to the end face 124, 224, 324, 424, 524, may be needed to modify industry-standard ferrules to achieve the laser manufacturing uses described herein.

In some such rapid heating processes, the low expansion material 112, 212, 312, 412, 512 is heated rapidly, to sinter, bond, and adhere to the higher-expansion material body 120, 220, 320, 420, 520 of the ferrule 110, 210, 310, 410, 510. According to an exemplary embodiment, the process takes less than 60 seconds, preferably less than 15 seconds. According to an exemplary embodiment, the rapid heating process uses a laser 328, CO and CO₂ lasers being preferred in some embodiments, with CO₂ lasers being more preferred.

In some embodiments, the rapid heating process utilizes a furnace with an optical and/or infra-red optical port with reflectors and/or optical concentrators. The optical port may be opened quickly to apply heat to the ferrule 110, 210, 310, 410; or the ferrule 110, 210, 310, 410 (to be processed) can be moved into the focus of a lens or reflector. In some preferred embodiments, the outer diameter D₄ of the ferrule remains near room temperature during the process, such as within 10° C. on average. In some embodiments, the ferrule body 120, 220, 320, 420 starts the heating process below room temperature.

In some embodiments, zirconia of the body 120, 220, 320, 520 of the ferrule 110, 210, 310, 510 can be sintered, with a well-shape 126, 226, 326, 526 in the zirconia formed by machining after the sintering. In some embodiments, the body 120, 220, 320, 520 of the ferrule 110, 210, 310, 510 (e.g., ceramic portion thereof) may be formed/shaped by extrusion, machined “green” (i.e., prior to sintering), and then sintered. In other embodiments, the body 120, 220, 320, 520 of the ferrule 110, 210, 310, 510 (e.g., ceramic portion thereof) may be formed/shaped by injection molding, dry bag or cold iso-static pressing, and/or by slip- or pressure casting.

According to an exemplary embodiment, a medium-magnitude thermal-expansion coefficient (e.g., between about 60 and 80×10⁻⁷/° C. expansion coefficient, such as about 70 ×10⁻⁷/° C. expansion), low-temperature sintering glass, glass A (mole-percentage): 59.08 SiO₂, 13.33 B₂O₃, 9.37 Al₂O₃, 8.03 Na₂O, 4.09 CaO, 1.28 Li₂O, 1.64 K₂O, 1.79 MgO, 1.37 ZrO₂; and a low-expansion (e.g., about 0 to 20×10⁻⁷/° C. expansion coefficient, such as about 0 to 10×10⁻⁷/° C. expansion coefficient), glass-ceramic, Glass B (mole-percentage): 60.0 SiO₂, 20.0 Al₂O₃, 20.0 ZnO, were used together. A silica “rod” of about 350 to 400 microns in diameter and 5.5 ×10⁻⁷/° C. expansion coefficient was also used. The silica “rod” was made by re-drawing a silica boule and can be made with an accurate inner diameter (bore) in the range of about 126 microns, thereby forming a simple ferrule. Another low expansion, glass-ceramic, composition contemplated for use with this or other embodiments includes Glass C (mole %): 59.0 SiO₂, 19.6 Al₂O₃, 12.4 ZnO, 6.8 Li₂O, 2.2 ZrO₂.

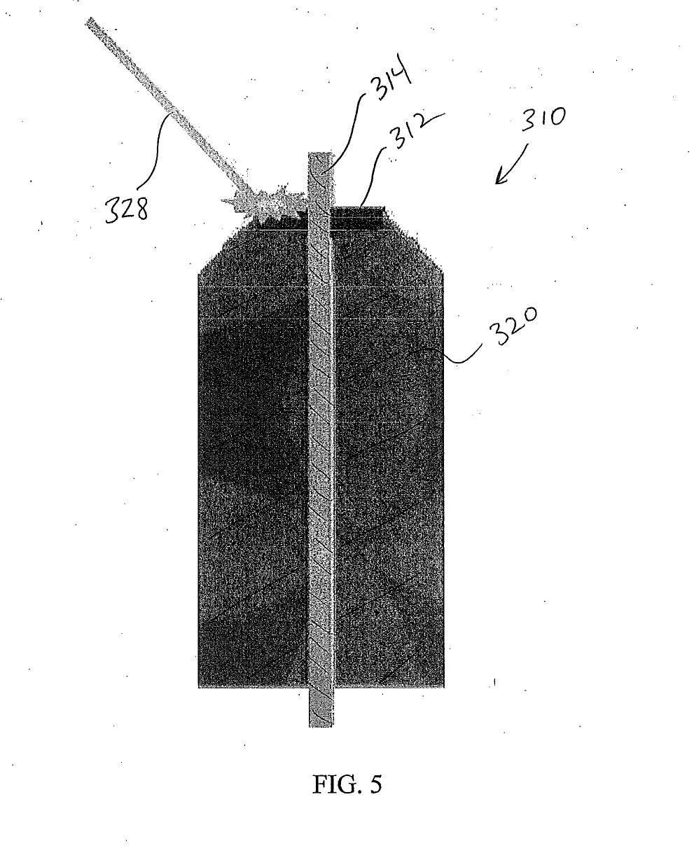

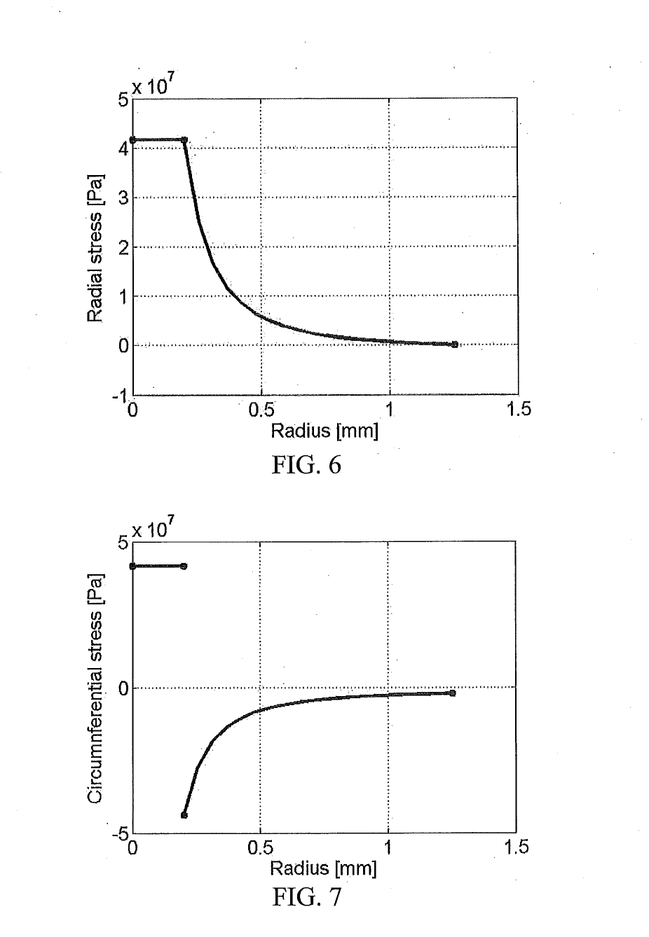

Referring to FIGS. 6-7, a semi-analytic stress model was developed for two- to five-layer structures of infinite-length, cylindrical-, elastic structures with the outer layer about 2.5 mm in diameter. The model gave circumferential and radial stress components as a function of radial distance. Further, the model allowed for different thermal expansion coefficients, Young's elastic moduli, Poisson's ratios and layer numbers and thicknesses. In the model, all the layers were assumed to be hollow cylinders except for the inner layer which was a solid cylinder and all the cylinders were concentric. FIG. 6 shows the estimated low radial stress when the zirconia ferrule starts at room temperature and glass is bonded at high temperature. FIG. 7 shows the estimated low circumferential stress when zirconia ferrule starts at room temperature and glass is bonded at high temperature.

The following examples, equations, and estimates are intended to provide general context for the present disclosure in the form of some specific examples.

### PROPHETIC EXAMPLE 1

Referring generally to FIG. 1, a zirconia ferrule 110 is machined to have a disk-shaped depression 126 in the tip at least 400 microns in diameter D₂ and at least 400 microns deep H₂. The ferrule 110 is macro-stress free at room temperature. The surface of the depression 126 in the ferrule is rapidly heated to 1100° C. in less than five seconds. The ferrule 110 is held at 1100° C. for less than 5 seconds. The ferrule 110 is allowed to cool to room temperature. If there is no phase transformation in the zirconia, if there is no creep at high temperature, and if there is no other non-elastic stress relieving mechanism, then the machined ferrule 110 will return to an essentially stress free state.

### PROPHETIC EXAMPLE 2

A zirconia ferrule 110 is machined to have a disk-shaped depression 126 in the tip 400 microns in diameter D₂ and 400 microns deep H₂. The ferrule 110 is macro-stress free at room temperature. A stripped waveguide 114 is inserted into the ferrule 110 and extends above the surface 124 of the ferrule 110. A glass powder is deposited in, above and slightly around the depression 126 in the ferrule 110. The surface 124 of the powder on and/or in the ferrule 110 is rapidly heated to 1100° C. in less than five seconds, perhaps by a CO₂ laser operating at about 10.6 microns wavelength. The powder is held at 1100° C. for less than 5 seconds and the powder sinters to closed porosity. The ferrule 110 and sintered glass are allowed to cool to room temperature. If there is no phase transformation in the zirconia, if there is no creep at high temperature, if there is no other non-elastic stress relieving mechanism, and if the glass has a low expansion, then the machined ferrule 110 and sintered glass 112 will return to a low stress state.

### PROPHETIC EXAMPLE 3

The stress model mentioned above was used to estimate the stresses in a high-expansion (zirconia) ferrule 110 with a low-thermal-expansion region (glass) 112 at one end 116 of the central part of the ferrule 110. An inner cylinder of glass 116 was modeled, with the properties listed in Table I (below) and with an outer diameter of 0.2 mm along with a zirconia cylinder 120 surrounding the inner cylinder of glass 116. Following the argument of Example 1, an outer cylinder of zirconia was assumed; but for the model, was given a very low thermal expansion coefficient (1×10⁻⁹/° C.) to simulate heating from room temperature, sintering the glass, then cooling (i.e. the zirconia 120 in the ferrule 110 will be essentially stress free except for the thermal contraction of the glass 112 after the glass 112 is bonded to the zirconia 120 at high temperature, then cools). 1100° C. was chosen as the glass sintering temperature. The model did not include any viscoelastic stress relaxation. Results show that in this model, there will be some stress in the glass 112 and the zirconia 120, but it is at a low level, approximately 42 MPa. Much higher stresses, approximately 900 MPa, are modeled, if a hot zirconia ferrule 110 is joined, stress free, to a 0.2 mm outer radii, low-expansion interior glass rod 114 at high temperature, then cooled (i.e., without the low-expansion material 112).

TABLE I

| | Young's | Poisson's | Thermal expansion | Layer outer |
|---|---|---|---|---|
| Layer # | modulus (GPa) | ratio | (/° C.) | radii (mm) |
| 1 | 72.9 | 0.14 | 5.5 × 10⁻⁷ | 0.2 |
| 2 | 210 | 0.31 | 1 × 10⁻⁹ | 1.25 |

### EXAMPLE 4

Glass A and glass-ceramic B were melted and ground to powders with a median particle size between about 2 to 10 microns. Glass A and glass-ceramic B where mixed in a 50%+50% ratio. A layer of the mixture of 50% glass A and 50% glass-ceramic B was spread in a steel bar die, a cleaned silica “rod” of between about 350-400 microns in diameter was placed in the die and a second layer of powder was placed on top and uni-axially pressed. The bar pre-form was placed in a latex iso-pressing bag, the air was removed by a vacuum pump and the bag was sealed. The bar was cold iso-statically pressed to about 25 kilopounds per square inch (kpsi). The pressed bar was placed on coarse alumina “setter” sand in an alumina sagger box and sintered at 800° C. or 900° C. in air for 4 hours. The bars were cross-sectioned and polished and examined by SEM.

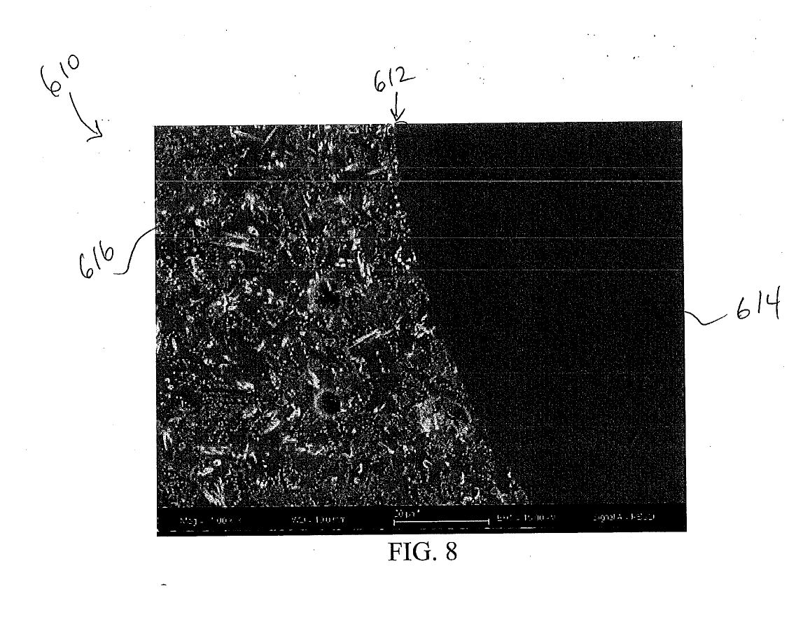

FIG. 8 shows a micrograph 610 including the interface 612 between the silica 614 and the sintered glass A+glass-ceramic B 616. No de-vitrification was found at the silica interface 612 and no fracture was found in the matrix sintered glass. As shown, the bonding is very good. An x-ray diffraction pattern of the 50/50 glass A/glass-ceramic B, indicated several different crystalline phases, Virgilite, Gahnite, Willemite and Albite and glassy halos.

### EXAMPLE 5

A ground bar of zirconia 3-mole % yttria was obtained from CoorsTek of Golden, Colo., USA. Fine, sub-micron silica soot and a thin piece, about 100 microns thick, of fused silica were placed on the zirconia bar. A CO₂ laser operating at about 10.6 microns wavelength was directed on to the bar, silica powder, and thin sheet. Using very little of the available power and translating the bar while irradiating the sample, the silica soot sintered to the bar and the thin glass sheet adhered to the bar.

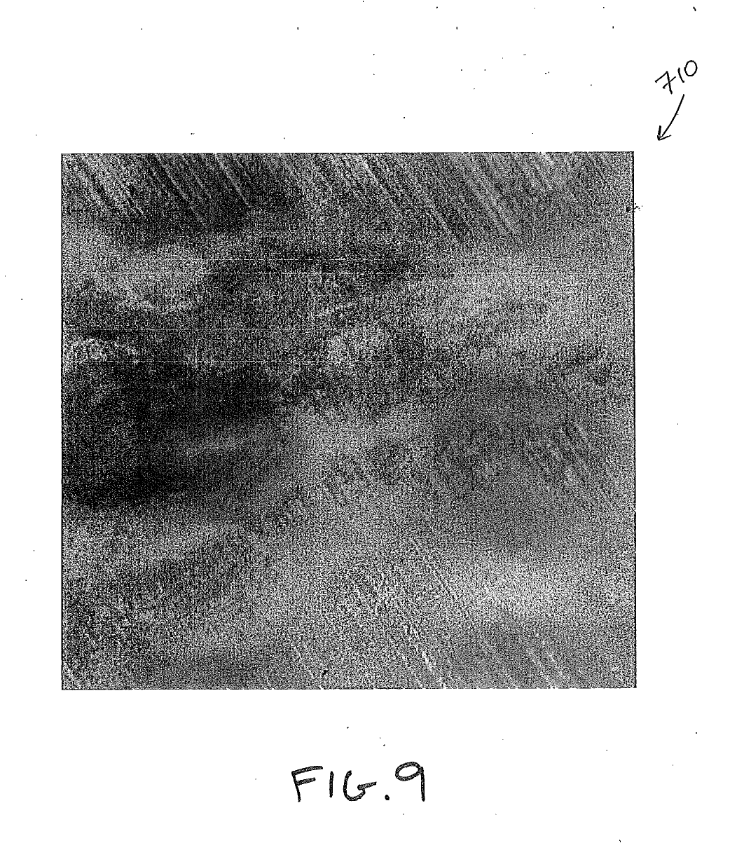

FIG. 9 is a micrograph 710 that shows the resulting glass sintered and adhered to the zirconia bar. The Figure shows that glass can be sintered and adhered to a zirconia bar without destruction of the zirconia or glass. FIG. 9 shows silica glass from powder and dense thin sheet that is sintered, bonded, and adhered to a zirconia bar. The bar began at room temperature and the sintering, bonding, and adhering heat was provided by a CO₂ laser.

In some contemplated embodiments, processes for using ferrules 110, 210, 310, 410, 510 disclosed herein include rapidly heating low-expansion material 112, 212, 312, 412, 512 of the ferrules 110, 210, 310, 410, 510 to sinter the low-expansion material 112, 212, 312, 412, 512 to the first material of the body 120, 220, 320, 420, 520. Some such processes may further include a step of machining a central hole 118, 218, 318, 418 (or bores 518) into the low-expansion material 112, 212, 312, 412, 512, after the low-expansion material 112, 212, 312, 412, 512 is sintered to the body 120, 220, 320, 420, 520. Some such processes may also further include machining the central hole 118, 218, 318, 418 (or bores 518) with a laser 328.

Referring now to FIG. 10, in some embodiments a multi-fiber ferrule 510 is manufactured and used according to the above disclosure. Accordingly, in some such embodiments, the multi-fiber high-expansion ferrule body 520 includes a low-expansion material 512 (e.g., glass) coupled to an end face 524 thereof and more than one bore 518 to receive optical fibers 514. The low-expansion material 512 may be connected across the end face 524 or may be dotted around bores 518 according to the dimensions disclosed above with respect the central bore 118, 218, 318, 418 of the embodiments shown in FIGS. 1-4. The multi-fiber ferrule 510 may support two, four, eight, twelve, sixteen, twenty-four, thirty-two, or other numbers of optical fibers 514. In some embodiments, the multi-fiber ferrule 510 is rectilinear, and the end face 524 is generally rectangular when viewed head on.

The low-expansion material 512, 112, 212, 312, 412 in this and the other embodiments disclosed herein may be used to attach the fiber 514, 114, 214, 314, 414 to the ferrule 510, 110, 210, 310, 410 (e.g., as a fastener, tack) by fusing to the cladding of the fiber 514, 114, 214, 314, 414 and/or may be used as a heat shield/sink to protect the ferrule 510, 110, 210, 310, 410 as the fiber 514, 114, 214, 314, 414 is laser-cleaved and/or laser-polished. Further, in some contemplated embodiments, the low-expansion material 512, 112, 212, 312, 412 may be used as a gasket or seal preventing fluid (e.g., gas and/or liquid) ingress or egress by way of the bore(s) 518, 118, 218, 318, 418.

The construction and arrangements of the ferrule systems and processes, as shown in the various exemplary embodiments, are illustrative only. Although only a few embodiments have been described in detail in this disclosure, many modifications are possible (e.g., variations in sizes, dimensions, structures, shapes, and proportions of the various elements, values of parameters, mounting arrangements, use of materials, colors, orientations) without materially departing from the novel teachings and advantages of the subject matter described herein. For example, the term “include,” and its variations, such as “including,” as used herein, in the alternative, means “comprising,” “primarily consisting of,” “consisting essentially of,” and/or “consisting of,” where possible in the particular usage herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present inventive technology.

What is claimed is:

1. An optical waveguide ferrule, comprising:
a body of the ferrule formed from a first material, the body having a bore extending lengthwise therethrough configured to receive an optical fiber along a central axis of the ferrule; and
a low-expansion material on one end of the body, whereby the low-expansion material is configured to be heated without damaging the body.

2. The optical waveguide ferrule of claim 1, wherein the difference in the thermal expansion of the body of the ferrule and the low-expansion material on the one end of the body is greater than 30×10⁻⁷/° C.

3. The optical waveguide ferrule of claim 2, wherein the low-expansion material extends radially along the end of the ferrule more than 25 microns from the bore of the ferrule.

4. The optical waveguide ferrule of claim 3, wherein the low-expansion material extends radially along the end of the ferrule less than 250 microns from the bore of the ferrule.

5. The optical waveguide ferrule of claim 3, wherein the low-expansion material extends radially from the bore to less than 90% of the outermost radius of the ferrule.

6. The optical waveguide ferrule of claim 5, wherein the low-expansion material extends into the ferrule less than half the depth of the ferrule as measured along an axis defined as concentric with the bore.

7. The optical waveguide ferrule of claim 2, wherein the ferrule comprises zirconia.

8. The optical waveguide ferrule of claim 7, wherein the low-expansion material is a glass or glass ceramic.

9. The optical waveguide ferrule of claim 8, wherein the low-expansion material has a graded composition that transitions from a lower-expansion composition near the optical fiber to higher-expansion composition near the body of the ferrule.

10. The optical waveguide ferrule of claim 2, wherein the low-expansion material is an inorganic crystalline material.

11. The optical waveguide ferrule of claim 10, wherein the low-expansion material comprises at least one of SiC, SiO₂, Si₃N₄, and solid solutions made from a polymer precursor.

12. The optical waveguide ferrule of claim 10, wherein the low-expansion material is an inorganic glass or glass ceramic material comprising silica.

13. The optical waveguide ferrule of claim 10, wherein the low-expansion material comprises an inorganic glass-ceramic or glass comprising at least one of bor-osilicate and beta-quartz.

14. The optical waveguide ferrule of claim 10, wherein the low-expansion material comprises an inorganic glass-ceramic or glass comprising:
glass A (in mole-percentage): 59.08% SiO₂, 13.33% B₂O₃, 9.37% Al₂O₃, 8.03% Na₂O, 4.09% CaO, 1.28% Li2O, 1.64% K₂O, 1.79% MgO, 1.37% ZrO₂; and
at least one of:
glass B (in mole-percentage): 60.0% SiO₂, 20.0% Al2O₃, 20.0% ZnO; and
glass C (in mole-percentage): 59.0% SiO₂, 19.6% Al₂O₃, 12.4% ZnO, 6.8 Li₂O, 2.2% ZrO₂.

15. A optical waveguide ferrule, comprising:
an elongate optical fiber;
a body of the ferrule formed from a first material, the body having a bore extending lengthwise therethrough, through which extends the optical fiber along a central axis of the bore;
a low-expansion material surrounding the optical fiber on an end of the body, wherein the low-expansion material at least partially fills a shallow well that extends into the endface of the body of the ferrule, wherein the low-expansion material is a glass, and wherein the bore extends to the well and the optical fiber extends from the bore at least partially through the well.

16. The optical waveguide ferrule of claim 15, wherein the ferrule comprises zirconia.

17. The optical waveguide ferrule of claim 16, wherein the glass comprises at least one of silica and boro-silicate glass.

18. The optical waveguide ferrule of claim 17, wherein the end of the ferrule is cleaved and the ferrule is a single-fiber ferrule.

19. The optical waveguide ferrule of claim 15, wherein the optical fiber is fused to the glass.

20. The optical waveguide ferrule of claim 15, wherein the glass extends radially more than 100 microns from the fiber on the end of the body; wherein the glass extends less than 250 microns from the fiber on the end of the body; and wherein the glass extends less than 1 mm deep into the ferrule as measured along the length of the optical fiber.
